(19) United States
(12) Patent Application Publication
(10) Pub. No.: US 2021/0409617 A1
(43) Pub. Date: Dec. 30, 2021

(54) DISPLAYING A THREE-DIMENSIONAL IMAGE OF A USER USING AN ARRAY OF INFRARED ILLUMINATORS

(71) Applicant: Micron Technology, Inc., Boise, ID (US)

(72) Inventors: Zahra Hosseinimakarem, Boise, ID (US); Carla L. Christensen, Boise, ID (US); Bhumika Chhabra, Boise, ID (US)

(21) Appl. No.: 16/911,115

(22) Filed: Jun. 24, 2020

(51) Int. Cl. H04N 5/33; H04N 9/31

(52) U.S. Cl. CPC H04N 5/33; G06F 3/167; H04N 9/3182; H04N 9/3194

(57) ABSTRACT

Methods, devices, and systems related to generating a three-dimensional (3-D) image using an array of infrared (IR) illuminators are described. In an example, a method can include projecting a number of IR dots on a user using a dot projector configured on a surface of a mobile device and an array of IR illuminators configured on the surface of the mobile device, capturing an IR image of the number of IR dots using an IR camera configured on the surface of the mobile device, and displaying a 3-D image of the user on a display or graphical user interface of the mobile device at least partially based on the captured IR image using a processing resource.

### TECHNICAL FIELD

The present disclosure relates generally to an array of infrared (IR) illuminators, and more particularly, to methods, apparatuses, and systems related to displaying a three-dimensional (3-D) image of a user using an array of IR illuminators.

### BACKGROUND

An IR illuminator can be, for example, a device that emits IR light. IR is a region of the electromagnetic radiation spectrum. Wavelengths in the IR region range from about 700 nanometers (NM) to 1 millimeter (mm). A dot projector can project IR light as a grid pattern. An IR camera, also known as a thermographic camera or thermal imaging camera, can capture IR light and form a heat zone image using the IR light.

### BRIEF DESCRIPTION OF THE DRAWINGS

FIG. 1 illustrates an example of a system for displaying a 3-D image of a user in accordance with a number of embodiments of the present disclosure.

FIG. 2 illustrates an example of an apparatus for displaying a 3-D image of a user in accordance with a number of embodiments of the present disclosure.

FIG. 3 illustrates an example of an apparatus for displaying a 3-D image of a user in accordance with a number of embodiments of the present disclosure.

FIG. 4 is a flow diagram of a method for displaying a 3-D image of a user in accordance with a number of embodiments of the present disclosure.

### DETAILED DESCRIPTION

The present disclosure includes methods, apparatuses, and systems related to displaying a 3-D image of a user using an array of IR illuminators. An example method includes projecting a number of IR dots on a user using a dot projector configured on a surface of a mobile device and an array of IR illuminators configured on the surface of the mobile device, capturing an IR image of the number of IR dots using an IR camera configured on the surface of the mobile device, and displaying a 3-D image of the user on a display or graphical user interface of the mobile device at least partially based on the captured IR image using a processing resource.

As used herein, a user can be one or more users. The 3-D image of the user can include an entire body of a user or a portion of the body of the user. A portion of the body of the user can be a face, head, eye, ear, nose, leg, arm, or hand, for example.

A single IR illuminator can emit IR light over an area and an array of IR illuminators (e.g., a plurality of IR illuminators) can emit IR light over a greater area. For example, where a single IR illuminator could emit IR light over a user's face, an array of IR illuminators could emit IR light over a user's entire body. Covering a user's entire body with IR light can allow the IR camera to capture an IR image of the user's entire body.

In a number of embodiments, a first portion of the number of IR dots can be projected by the dot projector on a first portion of a user's body and a second portion of the number of IR dots can be projected by the dot projector on a second portion of the user's body. In some examples, the first portion of the number of IR dots can be a first diameter and the second portion of the number of IR dots can be a second diameter. A dot diameter can be smaller when a dot is being projected on to a portion of the user's body where more detail in the 3-D image is desired and a dot diameter can be larger when a dot is being projected on to a portion of the user's body where less detail in the 3-D image is desired. The dot projector may project dots with smaller diameters on to a portion of the user's body where the user's body has more changes in contour, color, and/or shape. For example, the dot projector may project dots with smaller diameters on to a user's face and project dots with larger diameters on to a user's torso. In some examples, projecting an IR dot with a smaller diameter allows more dots to be projected in an area, which creates a more detailed 3-D image of the user in that area.

As such, the number of IR dots the dot projector projects on a portion of a user's body can be dependent on where more detail in the 3-D image is desired. The dot projector can project a first portion of the number of the IR dots on a first portion of the user's body and project a second portion of the number of the IR dots on a second portion of the user's body, where the first portion of the number of the IR dots is greater than the second portion of the number of IR dots. The dot projector may project a greater number of the IR dots on a portion of the user's body where the user's body has more changes in contour, color, and/or shape. For example, the dot projector may project a greater number of IR dots on to an ear of the user than on to a chin of the user because the user's ear has more contours than the user's chin.

In a number of embodiments, an axicon or an array of axicons can be used in conjunction with an array of IR illuminators, a dot projector, and/or an IR camera. An axicon is a cone shaped optical element with a circular aperture. The axicon can prevent light diffraction. An IR light can diffract and lose its intensity with distance. Placing an axicon in front of the dot projector will make the IR light diffraction free and allow the IR light to maintain its intensity over a greater distance. In some examples, an apparatus including an array of IR illuminators, a dot projector, an array of axicons, and an IR camera can project and capture an IR image of a number of IR dots at a greater distance away from the apparatus than an apparatus including the array of IR illuminators, the dot projection, and the IR camera without the array of axicons.

The IR camera can capture the IR light emitted by the array of IR illuminators and form an IR image (e.g., a heat zone image) using the number of IR dots. In a number of embodiments, a number of IR cameras can be used to capture a number of IR images. For example, each of the number of IR cameras can be located at different locations to capture IR images of the user on different sides of the user and/or different angles of the user.

A processing resource can generate and/or display a 3-D image of the user at least partially based on the captured IR image from the IR camera. The generated 3-D image can be a real-time 3-D image. As used herein, real-time can refer to the processing resource processing the IR image and producing a 3-D image using real-time data processing. A number of consecutive real-time 3-D images can be combined to display a real-time video of the user's body, motions, and/or expressions, for example.

As used herein, “a number of” something can refer to one or more of such things. For example, a number of computing devices can refer to one or more computing devices. A “plurality” of something intends two or more. Additionally, designators such as “X” and “Y”, as used herein, particularly with respect to reference numerals in the drawings, indicates that a number of the particular feature so designated can be included with a number of embodiments of the present disclosure.

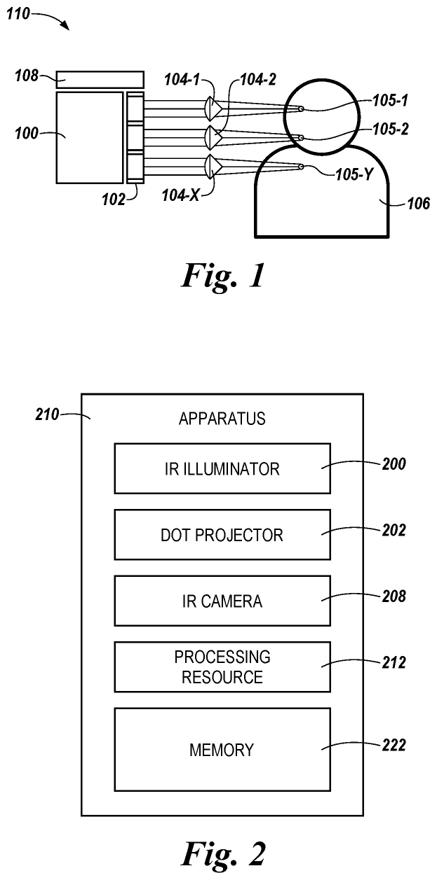

The figures herein follow a numbering convention in which the first digit or digits correspond to the drawing figure number and the remaining digits identify an element or component in the drawing. Similar elements or components between different figures may be identified by the use of similar digits. For example, reference numeral 102 may reference element “2” in FIG. 1, and a similar element may be referenced as 202 in FIG. 2. In some instances, a plurality of similar, but functionally and/or structurally distinguishable, elements or components in the same figure or in different figures may be referenced sequentially with the same element number (e.g., 104-1, 104-2, and 104-X in FIG. 1). As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

FIG. 1 illustrates an example of an apparatus 110 for displaying a 3-D image of a user 106 in accordance with a number of embodiments of the present disclosure. The apparatus 110 can be, but is not limited to, a mobile device, a head-mounted display, a wearable device, a television, a smart television, a gaming system, a piece of fitness equipment, a smart mirror, a computing device, a personal laptop computer, a desktop computer, a smart phone, a tablet, a digital camera, and/or redundant combinations thereof. The apparatus 110, as illustrated in FIG. 1, can include an infrared illuminator 100, a dot projector 102, a number of axicons 104-1, 104-2, . . . , 104-X, and an IR camera 108.

As used herein, a 3-D image can be a model and/or a figure representing a user. In some examples, the 3-D image can be used in virtual reality (VR), augmented reality (AR), and/or mixed reality (MR). The 3-D image of the user 106 can include an entire body of a user 106 or a portion of the body of the user 106.

A 3-D image of a user 106 can be rendered by combining one or more IR images captured by the IR camera 108. The one or more IR images can be created by projecting a number of IR dots 105-1, 105-2, . . . , 105-Y on a user 106 using a dot projector 102 and an IR illuminator 100 and capturing an IR image of the number of IR dots 105-1, 105-2, . . . , 105-Y using an IR camera 108.

The IR illuminator 100 can emit IR light. The IR illuminator 100 can be a single IR illuminator and/or an array of IR illuminators. As previously described, an array of IR illuminators can emit IR light over a greater area than a single IR illuminator. For example, a single IR illuminator can emit IR light over a portion of a user's body and an array of IR illuminators can emit IR light over a number of users. The IR illuminator 100 can be coupled to, included in, or on a surface of the apparatus 110.

The dot projector 102 utilizing the IR light emitted by the IR illuminator 100 can project the number of dots 105-1, 105-2, . . . , 105-Y directly on the user 106 and/or a number of users from the dot projector 102 and/or from the dot projector 102 through the number of axicons 104-1, 104-2, . . . , 104-X. For example, a first portion of the number of IR dots 105-1, 105-2, . . . , 105-Y can be projected by the dot projector 102 on a first user and a second portion of the number of IR dots 105-1, 105-2, . . . , 105-Y can be projected by the dot projector 102 on a second user. The dot projector 102 can be coupled to, included in, or on a surface of the apparatus 110.

In a number of embodiments, a first portion of the number of IR dots 105-1, 105-2, . . . , 105-Y can be projected by the dot projector 102 on a first portion of the body of the user 106 and a second portion of the number of IR dots 105-1, 105-2, . . . , 105-Y can be projected by the dot projector 102 on a second portion of the body of the user 106. For example, the first portion of the number of IR dots 105-1, 105-2, . . . , 105-Y can include IR dots 105-1 and 105-2 and the second portion of the number of IR dots 105-1, 105-2, . . . , 105-Y can include IR dot 105-Y.

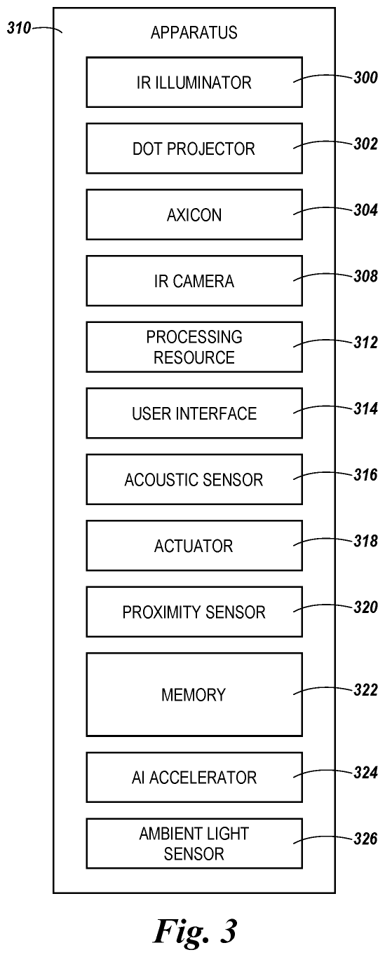

The first portion of the number of IR dots 105-1, 105-2, . . . , 105-Y can be a first diameter and the second portion of the number of IR dots 105-1, 105-2, . . . , 105-Y can be a second diameter. In some examples, the diameter of an IR dot can be determined by the distance the IR light is traveling from the IR projector 102. For example, the farther the IR light travels, the larger the IR dot will be, as such, the IR projector 102 can project a smaller IR dot when a user 106 is farther away and a larger IR dot when the user 106 is closer to the IR projector 102. As will be further described in FIG. 3, a proximity sensor can be used to determine a distance between the user 106 and the dot projector 102.

Although not shown in FIG. 1, an IR dot with a smaller diameter can be projected on to a portion of the user's body where more detail in the 3-D image is desired and an IR dot with a larger diameter can be projected on to a portion of the user's body where less detail in the 3-D image is desired. The dot projector 102 may project dots with smaller diameters on to a portion of the user's body where the user's body has more changes in contour, color, and/or shape. For example, the dot projector 102 may project IR dots with a smaller diameter on to a user's face and project IR dots with a larger diameter on to a user's body (e.g., neck, shoulders, chest, torso, arms, and/or legs, etc.). In some examples, projecting an IR dot diameter with a smaller diameter allows more IR dots to be projected in an area, which creates a more detailed 3-D image of the user 106 in that area.

The number of IR dots 105-1, 105-2, . . . , 105-Y the dot projector 102 projects on a portion of a user's body can be dependent on where more detail in the 3-D image is desired. The dot projector 102 can project a first portion of the number of the IR dots 105-1, 105-2, . . . , 105-Y on a first portion of the user's body and project a second portion of the number of the IR dots 105-1, 105-2, . . . , 105-Y on a second portion of the user's body. The first portion of the number of the IR dots 105-1, 105-2, . . . , 105-Y can be on a portion of the user's body where the user's body has more changes in contour, color, and/or shape and can include a greater number of IR dots 105-1, 105-2, . . . , 105-Y than the second portion of the number of IR dots 105-1, 105-2, . . . , 105-Y. For example, the dot projector 102 may project a greater number of the IR dots 105-1, 105-2, . . . , 105-Y on to an ear of the user 106 than on to a chin of the user 106 because the user's ear has more contours than the user's chin.

In a number of embodiments, an axicon 104 or an array of axicons 104-1, 104-2, . . . , 104-X can be used in conjunction with an IR illuminator 100, dot projector 102, and/or IR camera 108. An axicon 104 is a cone shaped optical element with a circular aperture. The axicon 104 can prevent light diffraction. An IR light can diffract and lose its intensity with distance. Placing an axicon 104 in front of the dot projector 102 will make the IR light diffraction free and allow the IR light to maintain its intensity over a greater distance. The axicon 104 can be coupled to and/or included in the apparatus 110. In some examples, an apparatus 110 including an IR illuminator 100, a dot projector 102, an array of axicons 104-1, 104-2, . . . , 104-X, and an IR camera 108 can project and capture a number of IR dots 105-1, 105-2, . . . , 105-Y at a greater distance away from the apparatus 110 than an apparatus without the array of axicons.

The IR camera 108 can capture the IR light emitted by the IR illuminator 100 and capture an IR image of the number of IR dots 105-1, 105-2, . . . , 105-Y. In a number of embodiments, a number of IR cameras 108 can be used to capture the number of IR dots 105-1, 105-2, . . . , 105-Y. For example, each of the number of IR cameras 108 can be located at different locations to capture the number of IR dots 105-1, 105-2, . . . , 105-Y on different sides of the user 106. The IR camera 108 can be coupled to, included in, or on a surface of the apparatus 110.

FIG. 2 illustrates an example of an apparatus 210 for displaying a 3-D image of a user in accordance with a number of embodiments of the present disclosure. Apparatus 210 can correspond to apparatus 110 in FIG. 1. The apparatus 210 can include an infrared illuminator 200, a dot projector 202, and an IR camera 208. The infrared illuminator 200, the dot projector 202, and the IR camera 208 can correspond to the infrared illuminator 100, the dot projector 102, and the IR camera 108, respectively in FIG. 1. As illustrated in FIG. 2, apparatus 210 can further include a processing resource 212 and a memory 222.

The memory 222 can be any type of storage medium that can be accessed by the processing resource 212 to perform various examples of the present disclosure. For example, the memory 222 can be a non-transitory computer readable medium having computer readable instructions (e.g., computer program instructions) stored thereon that are executable by the processing resource 212 to produce an IR light via an IR illuminator, project a number of IR dots on a user via the dot projector using the IR light produced by the IR illuminator, capture an IR image of the number of IR dots via an IR camera, and generate a 3-D image of the user at least partially based on the captured IR image.

The processing resource 212 can generate a 3-D image of a user by combining one or more IR images. The processing resource 212 can receive the one or more IR images from the IR camera 208 and/or from memory 222. In some examples, the processing resource 212 can combine an IR image from the IR camera 208 with an IR image from the memory 222. For example, the IR image from the IR camera can be less detailed than the IR image from memory 222 because it was captured from a greater distance away from the user than the IR image from the memory 222. The processing device 212 can use the IR image from the memory 222 with the IR image from the IR camera to create a more accurate 3-D image of the user.

In a number of embodiments, the memory 222 can store one or more 3-D images of the user. In some examples, the one or more 3-D images can be used when playing video games. For example, the one or more 3-D images can be used in AR, VR, and/or MR.

The memory 222 can be volatile or nonvolatile memory. The memory 222 can also be removable (e.g., portable) memory, or non-removable (e.g., internal) memory. For example, the memory 222 can be random access memory (RAM) (e.g., dynamic random access memory (DRAM) and/or phase change random access memory (PCRAM)), read-only memory (ROM) (e.g., electrically erasable programmable read-only memory (EEPROM) and/or compact-disc read-only memory (CD-ROM)), flash memory, a laser disc, a digital versatile disc (DVD) or other optical storage, and/or a magnetic medium such as magnetic cassettes, tapes, or disks, among other types of memory.

Further, although memory 222 is illustrated as being located within apparatus 200, embodiments of the present disclosure are not so limited. For example, memory 222 can be located on an external apparatus (e.g., enabling computer readable instructions to be downloaded over the Internet or another wired or wireless connection).

FIG. 3 illustrates an example of an apparatus 310 for displaying a 3-D image of a user in accordance with a number of embodiments of the present disclosure. Apparatus 310 can correspond to apparatus 210 in FIG. 2. The apparatus 310 can include an IR illuminator 300, a dot projector 302, an axicon 304, an IR camera 308, a processing resource 312, and a memory 322. The IR illuminator 300, the dot projector 302, the IR camera 308, the processing resource 312, and the memory 322 can correspond to the infrared illuminator 200, the dot projector 202, the IR camera 208, the processing resource 212, and the memory 222, respectively in FIG. 2. The axicon 304 can correspond to the axicon 104 in FIG. 1. As illustrated in FIG. 3, apparatus 310 can further include a user interface 314, an acoustic sensor 316, an actuator 318, a proximity sensor 320, an AI accelerator 324, and an ambient light sensor 326.

The user interface 314 can be generated by the apparatus 310. The user interface 314 can be a graphical user interface (GUI) that can provide and/or receive information to and/or from the user of the apparatus 310. The user interface 314 can be shown on a display of the apparatus 310.

In a number of embodiments, the user interface 314 can be generated in response to an input from a user. A user input to generate the user interface 314 can include powering on the apparatus 310 and/or selecting an application, for example.

Once the user interface 314 is generated on the apparatus 310, the user can view the 3-D image of the user and/or a 3-D image of the user previously generated. The user's movement captured by the IR camera can be used in generating a number of 3-D images that can be combined to create a video of the user's movement and expressions on the user interface 314. The one or more 3-D images of the user can be displayed in a video game and/or an instructional video on the user interface 314. For example, the user, the user's movements, and the user's expressions can be shown in real-time within a video game.

The apparatus 310 can include an acoustic sensor 316. The acoustic sensor 316 can detect sounds produced by a user. Detected sounds can include, but are not limited to, speaking, breathing, and/or footsteps, for example. The language, volume, and/or pitch of the sound captured by the acoustic sensor 316 can be analyzed by the processing resource 312.

In a number of embodiments, AI operations can be performed on the sound data using an AI accelerator 324. An AI accelerator can include hardware, software, and/or firmware that is configured to perform operations (e.g., logic operations, among other operations) associated with AI operations. In some examples, the AI operations can determine commands, user biometric data, and/or a user's distance from the apparatus 310.

A proximity sensor 320, for example, can also determine a distance between the user and the dot projector 302. In a number of embodiments, the apparatus 310 can receive the distance between the user and the dot projector 302 and select one or more IR dots to project based on the diameter of the one or more IR dots and the received distance between the dot projector 302 and the user.

A movement and/or acceleration of the user can be detected using the proximity sensor 320 and/or other sensors. The data collected by the proximity sensor 320 and/or other sensors from the user's movement and/or acceleration can be used to determine a speed of the user's movement, the force of the user's movement, and/or the direction of the user's movement. In some examples, the determined speed, the determined force, and/or the determined direction of the user's movement can be received by the apparatus 310 and displayed on the user interface 314 using a number of 3-D images.

The apparatus 310 can further include an actuator 318. The actuator 318 can be coupled to the IR illuminator 300, the dot projector 302, the axicon 304, and/or the IR camera 308. The actuator 318 can move (e.g., pan, tilt, rotate, etc.) the IR illuminator 300, the dot projector 302, the axicon 304, and/or the IR camera 308. In a number of embodiments, the actuator 318 can move the IR illuminator 300, the dot projector 302, the axicon 304, and/or the IR camera 308 in response to the proximity sensor 320 detecting the movement of the user. The actuator 318 can allow the apparatus 310 to continue capturing IR images and generating and/or displaying 3-D images of the user by following the user.

An ambient light sensor 326 can detect light that is already present where the user is located. Ambient light can be, for example, natural light and/or artificial light. In a number of embodiments, the intensity of the IR light emitted by the IR illuminator 300 can depend on the ambient light present where the user is located. For example, the IR illuminator 300 can emit a higher intensity IR light when the user is in a bright room filled with natural light and the IR illuminator 300 can emit a lower intensity IR light when the user is in a dark room.

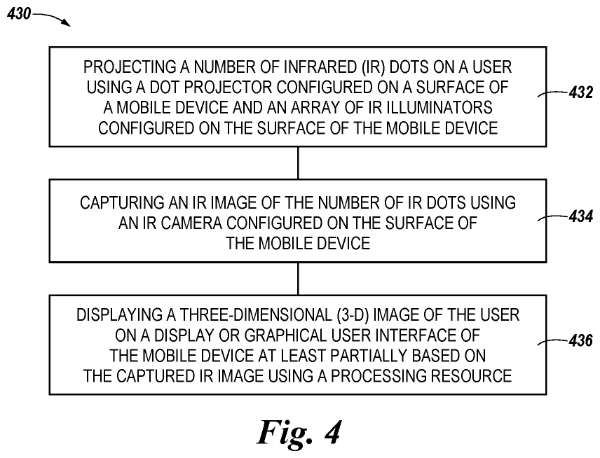

FIG. 4 is a flow diagram of a method 430 for displaying a 3-D image of a user in accordance with a number of embodiments of the present disclosure. At block 432, the method 430 can include projecting a number of IR dots on a user using a dot projector configured on a surface of a mobile device and an array of IR illuminators configured on the surface of the mobile device.

The array of IR illuminators can emit IR light. In some examples, the array of IR illuminators can emit varying intensities of IR light. The dot projector can utilize the IR light emitted by the array of IR illuminators to project the number of dots on the user and/or a number of users. The dot projector can project the number of dots in varying sizes. In some examples, the dot projector can change the number of dots projected.

At block 434, the method 430 can include capturing an IR image of the number of IR dots using an IR camera configured on the surface of the mobile device. The IR camera can capture the IR light emitted by the array of IR illuminators. The IR image can be a heat zone image, for example.

At block 436, the method 430 can include displaying a 3-D image of the user on a display or graphical user interface of the mobile device at least partially based on the captured IR image using a processing resource. The processing resource can generate a 3-D image of a user by combining one or more IR images. The processing resource can receive the one or more IR images from the IR camera and/or from memory. In some examples, the processing resource can combine an IR image from the IR camera with an IR image from the memory.

Although specific embodiments have been illustrated and described herein, those of ordinary skill in the art will appreciate that an arrangement calculated to achieve the same results can be substituted for the specific embodiments shown. This disclosure is intended to cover adaptations or variations of one or more embodiments of the present disclosure. It is to be understood that the above description has been made in an illustrative fashion, and not a restrictive one. Combination of the above embodiments, and other embodiments not specifically described herein will be apparent to those of skill in the art upon reviewing the above description. The scope of the one or more embodiments of the present disclosure includes other applications in which the above structures and methods are used. Therefore, the scope of one or more embodiments of the present disclosure should be determined with reference to the appended claims, along with the full range of equivalents to which such claims are entitled.

In the foregoing Detailed Description, some features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method, comprising:
projecting a number of infrared (IR) dots on a user using a dot projector configured on a surface of a mobile device and an array of IR illuminators configured on the surface of the mobile device;
capturing an IR image of the number of IR dots using an IR camera configured on the surface of the mobile device; and
displaying a three-dimensional (3-D) image of the user on a display or graphical user interface of the mobile device at least partially based on the captured IR image using a processing resource.

2. The method of claim 1, further comprising:
receiving a speed of a motion of the user; and
displaying the speed of the motion using a number of 3-D images.

3. The method of claim 1, further comprising:
receiving an acceleration of a motion of the user; and
displaying a force of the motion of the user using a number of 3-D images based on the received acceleration of the motion of the user.

4. The method of claim 1, further comprising:
receiving a distance between the dot projector and the user.

5. The method of claim 4, further comprising:
selecting one or more of the number of IR dots based on a diameter of the one or more number of IR dots and the received distance between the dot projector and the user.

6. The method of claim 1, further comprising:
projecting a first portion of the number of IR dots with a first diameter; and
projecting a second portion of the number of IR dots with a second diameter, wherein the second diameter is different than the first diameter.

7. The method of claim 6, further comprising:
projecting the first portion of the number of IR dots on a face of the user; and
projecting the second portion of the number of IR dots on a body of the user.

8. An apparatus, comprising:
an array of infrared (IR) illuminators on a surface of a mobile device configured to produce an IR light;
a dot projector on the surface of the mobile device configured to project a number of IR dots on a user using the IR light produced by the array of IR illuminators;
an IR camera on the surface of the mobile device configured to capture an IR image of the number of IR dots;
a processing resource of the mobile device configured to generate a three-dimensional (3-D) image of the user at least partially based on the captured IR image; and
a user interface of the mobile device to display the 3-D image.

9. The apparatus of claim 8, wherein the dot projector projects a different number of IR dots on a different user.

10. The apparatus of claim 8, further comprising:
an acoustic sensor configured to detect sounds produced by the user.

11. The apparatus of claim 8, further comprising:
an actuator coupled to the dot projector, wherein the actuator is configured to move the dot projector.

12. The apparatus of claim 11, wherein the actuator is configured to move the dot projector responsive to movement of the user.

13. The apparatus of claim 12, further comprising:
a proximity sensor configured to detect the movement of the user.

14. An apparatus, comprising:
an array of infrared (IR) illuminators on a surface of a mobile device configured to produce an IR light;
a dot projector on the surface of the mobile device configured to project a number of IR dots on a user using the IR light produced by the array of IR illuminators;
an axicon coupled to or included in the mobile device configured to prevent the IR light from diffracting;
an IR camera on the surface of the mobile device configured to capture an IR image of the number of IR dots;
a processing resource of the mobile device configured to generate a three-dimensional (3-D) image of the user at least partially based on the captured IR image; and
a user interface of the mobile device configured to display the generated 3-D image.

15. The apparatus of claim 14, further comprising:
a memory configured to store one or more previously captured IR images of the user.

16. The apparatus of claim 15, wherein the one or more previously captured IR images of the user include a first previously captured IR image and a second previously captured IR image, wherein the user is a first distance from the dot projector in the first previously captured IR image and the user is a second distance from the dot projector in the second previously captured IR image.

17. The apparatus of claim 15, wherein the 3-D image of the user is generated at least partially using the one or more previously captured IR images of the user.

18. The apparatus of claim 14, further comprising:
a memory configured to store the generated 3-D image.

19. The apparatus of claim 14, further comprising:
an ambient light sensor, wherein an intensity of the infrared light produced by the IR illuminator is at least partially based on a reading of the ambient light sensor.

20. The apparatus of claim 14, wherein the user interface displays the 3-D image in a video game or an instructional video.
